(19) United States
(12) Patent Application Publication
(10) Pub. No.: US 2026/0085494 A1
(43) Pub. Date: Mar. 26, 2026

(54) METHOD AND SYSTEM FOR HYDRAULIC FLOW CONTROL OF AUTOMATION SYSTEMS FOR WORK IMPLEMENTS OF WORK MACHINES

(71) Applicant: Deere & Company, Moline, IL (US)

(72) Inventors: Aaron R. Kenkel, Hazel Green, WI (US); Jeffery W. Dobchuk, Saskatoon (CA); Justin A. Sticksel, Platteville, WI (US)

(21) Appl. No.: 18/890,887

(22) Filed: Sep. 20, 2024

(51) Int. Cl. E02F 9/22; E02F 3/32; E02F 3/43

(52) U.S. Cl. CPC E02F 9/2203; E02F 9/2217; E02F 3/32; E02F 3/435; E02F 9/2285

(57) ABSTRACT

A computer-implemented method for regulating the movement rate of a work implement in a work machine involves generating a velocity request for a first actuator from the machine control system, receiving a signal indicating the velocity of the first actuator, and producing a velocity control signal based on the request and the velocity signal. Additionally, signals representing the initial position of a second actuator associated with a directional control valve are received, enabling the generation of a valve force control signal to adjust the second actuator's subsequent position and a flow control signal to manage the hydraulic pump output. The method iterates through these steps to maintain control over the work implement's movement rate.

### FIELD OF DISCLOSURE

The present disclosure relates generally to work machines such as construction and forestry machines, and more particularly to methods and systems for controlling hydraulic flow in automation systems for work implements of work machines.

### BACKGROUND

Previous methods for controlling the rate of movement of a work implement for a work machine have typically involved utilizing machine control systems to generate velocity requests for actuators associated with the work implement. These requests are based on various parameters such as desired speed or position of the work implement. The velocity measurements of the actuators are then monitored to ensure that the work implement is moving at the desired rate. However, existing approaches have faced challenges in accurately controlling the movement of the work implement due to limitations in the feedback mechanisms used to monitor the velocity of the actuators.

In some conventional systems, the control signals generated based on the velocity requests and velocity measurements may not adequately account for external factors that can affect the movement of the work implement. For instance, variations in the initial position of actuators associated with directional control valves, which regulate the flow of hydraulic fluid to the actuators, can impact the overall performance of the system. As a result, there is a need for improved methods that can dynamically adjust the control signals based on the initial position of the actuators to optimize the rate of movement of the work implement.

Moreover, existing techniques for controlling the rate of movement of work implements in work machines may lack the ability to efficiently coordinate the operation of multiple actuators and control valves to achieve smooth and precise movement. The coordination between the actuators and control valves is crucial for ensuring that the work implement moves in a controlled manner without delays or inconsistencies. Therefore, there is a demand for innovative approaches that can integrate the control of multiple actuators and control valves to enhance the overall performance of the work machine. However, none of these approaches have provided a comprehensive solution that combines the features described in this disclosure.

In light of the foregoing limitation in existing control methodologies of the rate of hydraulic flow for work implements of work machines, it is desirable to accurately compensate for factors within the hydraulic automation system and accurately control the rate of actuator movement associated with the work implement.

### BRIEF SUMMARY

The current disclosure provides an enhancement to conventional systems, at least in part by introducing a novel method and system for controlling a rate of hydraulic flow through an automation system of a work machine with a work implement.

In one particular and exemplary embodiment, a computer-implemented method is provided herein for controlling movement of an implement for a work machine

In some aspects, the techniques described herein relate to a computer-implemented method of controlling a rate of movement of a work implement for a work machine, including: in step (a), generating a velocity request for a first actuator from a machine control system of the work machine, where the first actuator is one or more of a plurality of first actuators associated with the work implement; in step (b), receiving a signal representing a velocity measurement of the first actuator; in step (c), generating a velocity control signal based on the velocity request and the signal representing the velocity measurement of the first actuator; receiving signals representative of an initial position of a second actuator, where the second actuator is one or more of a plurality of second actuators associated with a directional control valve, the directional control valve being operably disposed between a hydraulic pump and the first actuator; based at least upon the initial position of the second actuator, generating a valve force control signal to control a subsequent position of the second actuator and generating a flow control signal to control an output of a hydraulic pump; and repeating steps (a)-(c) based on the valve force control signal and the flow control signal.

In some aspects, the techniques described herein relate to a method, further including: determining, based at least on the initial position of the second actuator, a flow force, a spool force, a valve passage flow, and an expected regenerative flow; generating, based at least on the initial position of the second actuator, the flow force, and the spool force, the valve force control signal to control the subsequent position of the second actuator; and generating, based on the valve passage flow, the expected regenerative flow, and the velocity control signal, the flow control signal to control the output of the hydraulic pump.

In some aspects, the techniques described herein relate to a method, further including: receiving, from a pressure sensor disposed between the hydraulic pump and the directional control valve, a signal representative of an output pressure of the hydraulic pump; wherein determining the expected regenerative flow includes: receiving a plurality of signals representing a system pressure, where one of the plurality of signals representing the system pressure includes the signal representing the output pressure of the hydraulic pump; estimating, based on the plurality of signals representing the system pressure and the velocity control signal, a load of the first actuator; and generating, based on the load of the first actuator, an output signal representing a quantity of flow to regenerate into the first actuator.

In some aspects, the techniques described herein relate to a method, wherein receiving a plurality of signals representing the system pressure includes: receiving a signal representing a pressure at an inlet of the first actuator, an outlet of the first actuator, or both.

In some aspects, the techniques described herein relate to a method, further including: generating, based at least on the expected regenerative flow, the valve force control signal to control the subsequent position of the second actuator.

In some aspects, the techniques described herein relate to a method, wherein determining the valve passage flow includes: determining, based at least on a predefined flow metering curve associated with the directional control valve, a flow rate representative of the initial position of the second actuator, wherein the predefined flow metering curve includes a plurality of flow rates respectively associated with a plurality of positions of the second actuator.

In some aspects, the techniques described herein relate to a method, wherein determining the flow force includes: dynamically receiving, from one or more of a plurality of sensors, at least one signal representing a flow force data; dynamically receiving a signal representing a plurality of positions of the second actuator, the plurality of positions of the second actuator including the initial position and the subsequent position of the second actuator; time series matching the at least one signal representing flow force data to the signal representing the plurality of positions of the second actuator, where the at least one signal representing flow force data and the signal representing the plurality of positions of the second actuator each include a plurality of measurements over a period of time; and generating, based on the time series matching, an output signal representing a compensated flow force.

In some aspects, the techniques described herein relate to a method, wherein determining the flow force includes: receiving a first data set, the first data set including a plurality of predefined system data; deriving, through a dynamic system model and from the first data set, a second data set, the second data set including flow force data; dynamically estimating, based upon the second data set of the dynamic system model, a flow force data according to a plurality of positions of the second actuator, the plurality of positions of the second actuator including the initial position and the subsequent position of the second actuator; and generating, based on the dynamically estimated flow force data, an output signal representing a compensated flow force.

In some aspects, the techniques described herein relate to a method, wherein generating the valve force control signal further includes: dynamically comparing the valve force control signal to the subsequent position of the second actuator; dynamically generating, based on the dynamically compared valve force control signal to the subsequent position of the second actuator, a compensatory signal; and modifying the valve force control signal with the compensatory signal.

In some aspects, the techniques described herein relate to a method, wherein generating the valve force control signal further includes: receiving a first data set, the first data set including a plurality of compared data, the plurality of compared data representing a comparison of the valve force control signal to the subsequent position of the second actuator; deriving, through a dynamic system model and from the first data set, a second data set, the second data set including a hysteresis compensator; and dynamically estimating, based upon the second data set of the dynamic system model, the hysteresis compensator according to a plurality of positions of the second actuator, the plurality of positions of the second actuator including the initial position and the subsequent position of the second actuator.

In some aspects, the techniques described herein relate to a method, wherein repeating step (c) further includes: generating a target error by comparing the velocity request with the signal representing the velocity measurement; and modifying the velocity control signal with the target error.

In some aspects, the techniques described herein relate to a method, further including: generating a proportional target error; generating an integral target error; combining the proportional target error and the integral target error; and modifying the target error with the combined proportional target error and integral target error.

In some aspects, the techniques described herein relate to a work machine, including: a work implement; a hydraulic pump; a first actuator associated with the work implement of the work machine; at least one first sensor operably connected to the first actuator; a directional control valve disposed between the hydraulic pump and the first actuator; a second actuator operably connected to the directional control valve; a second sensor operably connected to the second actuator, the second sensor configured to generate a position signal representing a position of the second actuator; and a controller configured to generate a velocity request signal for regulating a velocity of the first actuator, the controller further configured to: determine, from the at least one first sensor, a velocity error of the first actuator based on a velocity measurement signal representing a velocity of the first actuator and on an initial velocity control signal; generate, based on the velocity error, an actuator velocity control signal; determine, from the second sensor, an initial position of the second actuator; and generate, based upon the initial position and the actuator velocity control signal, a plurality of control signals, where the plurality of control signals includes a second actuator control signal and a hydraulic pump flow control signal.

In some aspects, the techniques described herein relate to a work machine, further including: a first pressure sensor disposed between the hydraulic pump and the directional control valve, the first pressure sensor providing a signal representing a pressure of the hydraulic pump; wherein the controller is further configured to generate, based on the signal representing the pressure of the hydraulic pump and the initial position of the second actuator, a control signal representing a quantity of flow to regenerate into the first actuator.

In some aspects, the techniques described herein relate to a work machine, further including: a second pressure sensor disposed at an inlet of the first actuator, an outlet of the first actuator, or both, the second pressure sensor providing a signal representing a pressure associated with the first actuator; wherein the controller is further configured to: estimate, based at least on the first pressure sensor and the second pressure sensor, a load of the first actuator; and generate, based on the load of the first actuator, the control signal representing a quantity of flow to regenerate into the first actuator.

In some aspects, the techniques described herein relate to a work machine, further including: a third sensor configured to generate a plurality of flow signals, each of the plurality of flow signals representing a flow across the directional control valve; wherein the controller is further configured to: dynamically receive, from the third sensor, the plurality of flow signals respectively associated with a plurality of positions of the second actuator, the plurality of positions of the second actuator including the initial position; and determine, based on the plurality of flow signals respectively associated with the plurality of positions of the second actuator, a flow loss rate corresponding to the initial position of the second actuator.

In some aspects, the techniques described herein relate to a work machine, further including: a first pressure sensor disposed between the hydraulic pump and the directional control valve, the first pressure sensor providing a pressure signal representing a pressure of the hydraulic pump; and a third sensor configured to generate a flow force input signal, the flow force input signal representing a flow force associated with the directional control valve; wherein the controller is further configured to: dynamically receive the position signal, the pressure signal, and the flow force input signal, where each of the position signal, the pressure signal, and the flow force input signal include a plurality of measurements over a period of time; associate the flow force input signal with the position signal and the pressure signal; and generate, based on the flow force input signal associated with the position signal and the pressure signal, a flow force compensation signal.

In some aspects, the techniques described herein relate to a work machine, wherein the controller is further configured to: dynamically compare the position signal to the flow force compensation signal, the position signal and the flow force compensation signal include a plurality of measurements over the period of time; dynamically generate, based on the dynamically compared position signal and flow force compensation signal, a hysteresis compensation signal; and modify the second actuator control signal with the hysteresis compensation signal.

In some aspects, the techniques described herein relate to a work machine, further including:

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side view representing an excavator as an exemplary work machine according to an aspect of the present disclosure.

FIG. 2 is a block diagram representing an exemplary control system according to an aspect of the present disclosure.

FIG. 3 is a flowchart representing an exemplary aspect of a method as disclosed herein.

FIG. 4 is a block diagram representing an exemplary hydraulic system according to an aspect of the present disclosure.

FIG. 5 depicts an aspect of the step of determining 350 the expected regenerative flow 352 according to the disclosure.

FIG. 6 depicts an aspect of the step of determining 346 the valve passage flow 348 according to the disclosure.

FIG. 7 depicts an aspect of the step of determining 338 the flow force 340 according to the disclosure.

### DETAILED DESCRIPTION

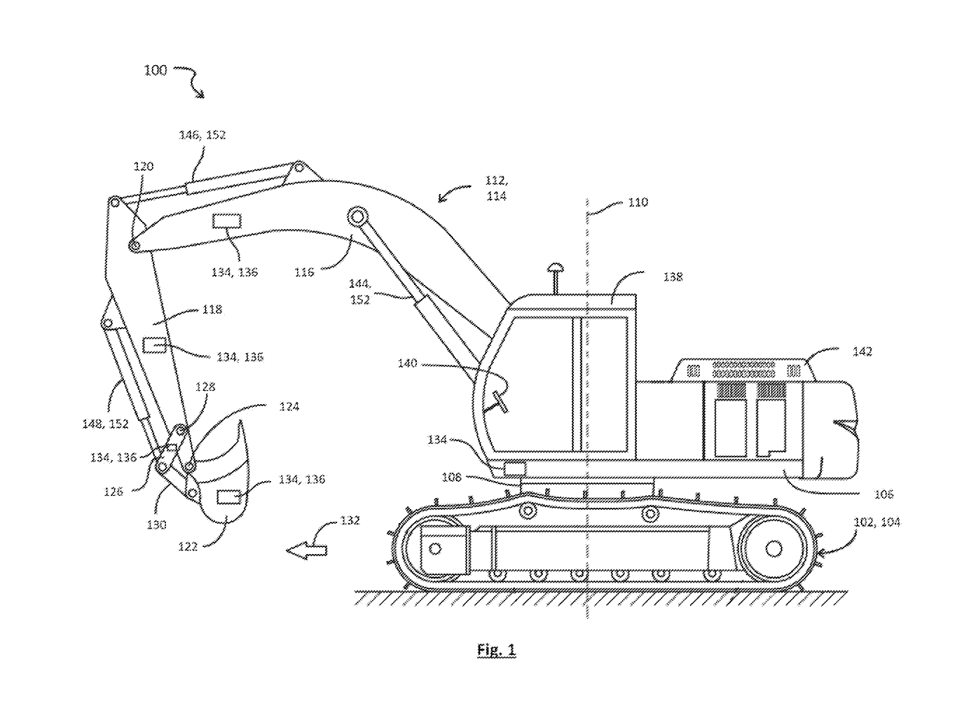

Referring now to FIGS. 1-7, various embodiments may now be described of a system and method for controlling a rate of movement of a work implement for work machines.

FIG. 1 depicts an embodiment of a work machine 100 in accordance with the present disclosure. Although the example provided and further described below for illustrative purposes is in the form of a tracked excavator machine, one of skill in the art may appreciate that various alternative forms of work machines may be contemplated with the scope of the present disclosure, and any inventive features are not limited to machines which are tracked, self-propelled, or based on a particular work environment or purpose.

The work machine 100 according to the embodiment in FIG. 1 may include an undercarriage 102, which may include one or more ground engaging units 104 and one or more travel motors (not shown) for driving the one or more ground engaging units 104, respectively. The work machine 100 includes a main frame 106 that may be supported from the undercarriage 102 by a swing bearing 108 such that the main frame 106 may be pivotable about a pivot axis 110 relative to the undercarriage 102.

A work implement 112 may be provided as a boom assembly 114, which includes a boom 116, an arm 118 pivotally connected to the boom 116 at a linkage joint 120, and a working tool 122. The boom 116 may be pivotally attached to the main frame 106 to pivot about a generally horizontal axis relative to the main frame 106. The working tool 122 in this embodiment is an excavator shovel, which is pivotally connected to the arm 118 at a linkage joint 124. One end of a dogbone 126 is pivotally connected to the arm 118 at a linkage joint 128, and another end of the dogbone 126 is pivotally connected to a tool link 130. A tool link 130 in the context of the excavator shovel is a bucket link.

The boom assembly 114 may extend from the main frame 106 along a working direction 132 of the boom assembly 114. As described herein, control of the work implement 112 may relate to control of any one or more of the associated components, including, but not limited to, the boom 116, arm 118, and working tool 122.

The work machine 100 may also include a plurality of sensors 134, which may be externally associated with components of the work implement 112, may be associated with internal hydraulic or electrical components (not shown), or any other associated structures of the work machine 100 that operate to control the movement of the working tool 122. In an illustrative example, the plurality of sensors 134 may be associated with the main frame 106, the boom 116, the arm 118, the dogbone 126, and the working tool 122. In some aspects, the plurality of sensors 134 may include at least one first sensor 135, where each sensor of the at least one first sensor 135 may be operably connected to the first actuator 150 of the plurality of first actuators 152. The plurality of sensors 134 will be described further herein.

An operator cab 138 may be located on the main frame 106. The operator cab 138 and the boom assembly 114 may both be mounted on the main frame 106 so that the operator cab 138 faces in the working direction 132 of the boom assembly. A control station 140 may be located in the operator cab 138.

An engine 142 may be mounted on the main frame 106 for powering the work machine 100. The engine 142 may be a diesel internal combustion engine. The engine 142 may drive a hydraulic pump to provide hydraulic power to the various operating systems of the work machine 100.

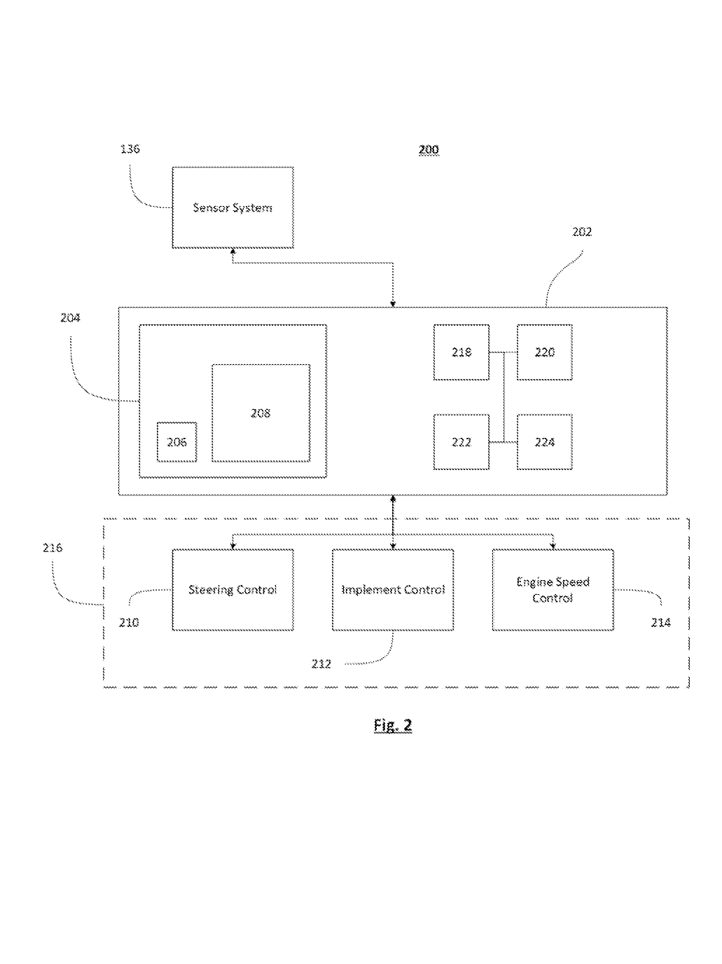

FIG. 2 depicts a schematic illustration of a control system 200 of the work machine 100 according to the disclosure. The control system 200 includes a controller 202. The controller 202 may be part of the machine control system of the working machine, or it may be a separate control module. The controller 202 may include a user interface 204 and optionally be mounted in the operator cab 138 at the control station 140.

The controller 202 is configured to receive input signals from some or all of the plurality of sensors 134 collectively defining a sensor system 136, individual examples of which may be described below. Various sensors on the sensor system 136 may typically be discrete in nature, but signals representative of more than one input parameter may be provided from the same sensor, and the sensor system 136 may further refer to signals provided from the machine control system.

The sensor system 136 in the context of the work machine 100 may constitute a system of sensors configured to sense aspects of the work machine 100 that impact control of the work implement 112. The sensor system 136 may include a system of inertial measurement units (each, an IMU). IMUs are tools that capture a variety of motion- and position-based measurements, including, but not limited to, velocity, acceleration, angular velocity, and angular acceleration. IMUs include a number of sensors including, but not limited to, accelerometers, which measure (among other things) velocity and acceleration, and gyroscopes, which measure (among other things) angular velocity and angular acceleration. Generally, an accelerometer provides measurements, with respect to (among other things) force due to gravity, while a gyroscope provides measurements, with respect to (among other things) rigid body motion.

The sensor system 136 may also include a system of position sensors to determine the position of various additional components relevant to the functions described herein, including such components as may be associated with the relative positions of actuators associated with one or more elements of the work implement.

The controller 202 may be configured to produce outputs, as further described below, to the user interface 204 for display to the human operator. The controller 202 may further, or in the alternative, be configured to generate control signals for controlling the operation of respective actuators, or signals for indirect control via intermediate control units, associated with a machine steering control system 210, an implement control system 212, and an engine speed control system 214. The controller 202 control signals may control the operation of respective actuators, or signals for indirect control via intermediate control units, associated with any of a machine control system 216, which includes at least the machine steering control system 210, the implement control system 212, and the engine speed control system 214. The controller 202 may, for example, generate control signals for controlling the operation of various actuators, such as hydraulic motors or hydraulic piston-cylinder units 144, 146, 148, and electronic control signals from the controller 202 may actually be received by electro-hydraulic control valves associated with the actuators such that the electro-hydraulic control valves will control the flow of hydraulic fluid to and from the respective hydraulic actuators to control the actuation thereof in response to the control signal from the controller 202.

The controller 202 may include, or be associated with, a processor 218, a computer readable medium 220, a communication unit 222, data storage 224 such as for example a database network, and the aforementioned user interface 204 having a display 208. An input-output device 206, such as a keyboard, joystick or other user interface tool, is provided so that the human operator may input instructions to the controller 202. It is understood that the controller 202 described herein may be a single controller having all of the described functionality, or it may include multiple controllers wherein the described functionality is distributed among the multiple controllers.

Various operations, steps or algorithms as described in connection with the controller 202 and method 300 can be embodied directly in hardware, in a computer program product such as a software module executed by the processor 218, or in a combination of the two. The computer program product can reside in RAM memory, flash memory, ROM memory, EPROM memory, EEPROM memory, registers, hard disk, a removable disk, or any other form of computer-readable medium 220 known in the art. An exemplary computer-readable medium 220 can be coupled to the processor 218 such that the processor 218 can read information from, and write information to, the memory/storage medium 220. In the alternative, the medium 220 can be integral to the processor 218. The processor 218 and the medium 220 can reside in an application specific integrated circuit (ASIC). The ASIC can reside in a user terminal. In the alternative, the processor 218 and the medium 220 can reside as discrete components in a user terminal.

The term “processor” 218 as used herein may refer to at least general-purpose or specific-purpose processing devices and/or logic as may be understood by one of skill in the art, including but not limited to a microprocessor, a microcontroller, a state machine, and the like. A processor 218 can also be implemented as a combination of computing devices, e.g., a combination of a digital signal processor (DSP) and a microprocessor, a plurality of microprocessors, one or more microprocessors in conjunction with a DSP core, or any other such configuration.

The communication unit 222 may support or provide communications between the controller 202 and external systems or devices, such as for example to implement or otherwise support a distributed computing environment for executing one or more steps or functions in a process as disclosed herein, and/or support or provide communication interface with respect to internal components of the work machine 100. The communication unit 222 may include wireless communication system components (e.g., via cellular modem, satellite connectivity, WiFi, Bluetooth, or the like) and/or may include one or more wired communications terminals such as universal serial bus ports.

The data storage 224 as further described below may, unless otherwise stated, generally encompass hardware such as volatile or non-volatile storage devices, drives, memory, or other storage media, as well as one or more databases residing thereon.

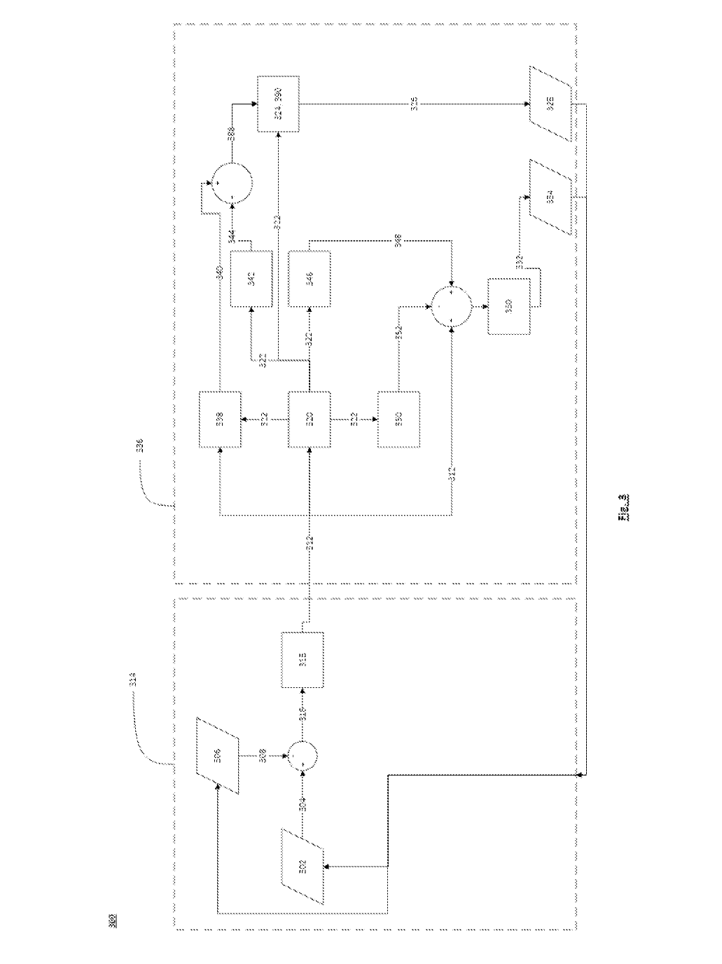

FIG. 3 depicts an aspect of a method 300 for controlling a rate of movement of the work implement 112 of the work machine 100 according to the disclosure. The method 300 may commence with a step of generating 302 a velocity request 304 for a first actuator 150 from a machine control system 210 of the work machine 100. The first actuator 150 may include the hydraulic piston-cylinder units 144, 146, 148 or any one of a plurality of first actuators 152 associated with the work implement 112 of the work machine 100. In an exemplary aspect, the step of generating 302 the velocity request 304 may be provided as the controller 202 receiving a request from the machine control system 216 for a velocity request for any one of the plurality of first actuators 152. Knowledge of any particular first actuator 150 of the plurality of first actuators 152 allows the control system 200 to translate any velocity measurement or parameter to a flow measurement or parameter based on the size of the first actuator 150. In an aspect of this disclosure, the measurements and parameters associated with velocity of an actuator may be a proxy for the measurements and parameters associated with flow of an actuator, and vice versa.

The method 300 may also include a step of receiving 306 a velocity measurement signal 308 representing a velocity measurement of the first actuator 150. The velocity measurement signal 308 representing the velocity measurement of the first actuator 150 may be provided by the one or more of the plurality of sensors 134 or an aspect of the sensor system 136 generally. In an exemplary aspect, the velocity measurement may be provided by one or more of the inertial measurement units of the sensor system 136. The velocity measurement may also be provided by other aspects of the sensor system 136 capable of generating the velocity measurement signal 308 representing the velocity measurement of the first actuator 150. For instance, the sensor system 136 may include one or more position sensors associated with one or more of the plurality of first actuators 152. The position sensors may determine the position of various components, including an extension of a hydraulic cylinder associated with the first actuator 150, a position of a spool associated with a directional control valve, any aspect of a component of the control system 200 that may provide information indicating a position of the component relative to another component or itself, or a combination thereof. The position sensors may include linear variable differential transformers, magnetorestrictive linear displacement, a contact displacement sensor, a rotary encoder, or other suitable linear or rotary position measuring device.

The method 300 may also include a step of generating a velocity control signal 312. In some aspects of the disclosure, the velocity control signal 312 provides similar information and information of the same type as provided by the velocity request 304. The step of generating the velocity control signal 312 may be based on the velocity request 304 and the velocity measurement signal 308. Where the velocity control signal 312 is provided to control the velocity of one or more first actuator 150 of the plurality of first actuators 152, the step of generating the velocity control signal 312 may be based on the velocity request 304 associated with the same first actuator 150 or may be associated with others of the plurality of first actuators 152 that may affect the velocity control signal 312 for the first actuator 150. Similarly, the step of generating the velocity control signal 312 may be based on the velocity measurement signal 308 associated with the first actuator 150 that is to be controlled by the velocity control signal 312. In some aspects of the disclosure, the step of generating the velocity control signal 312 may be based on the velocity measurement signal 308 associated with another actuator of the plurality of first actuators 152 that may indicate a measured actuator velocity associated with the first actuator 150.

In some aspects of this disclosure, the velocity control signal 312 may be generated based at least in part on a closed-loop control 314. The closed-loop control 314 may utilize both the velocity request 304 and the velocity measurement signal 308 to generate a target error 316 (a velocity error). The closed-loop control 314 may generate the target error 316 by comparing the velocity request 304 and the velocity measurement signal 308. The target error 316 may drive a proportional-integral P-I closed loop control 318. The P-I closed loop control 318 of the closed-loop control 314 may ultimately impact the output control signals generated by the 300 as discussed further herein. The P-I closed loop control 318 may be used to modify the velocity control signal 312 based on the target error 316.

The method 300 may include a step of receiving 320 signals representative of an initial position 322 of a second actuator 154. The second actuator 154 may be one or more of a plurality of second actuators 156, each second actuator 154 associated with a directional control valve 158. In an exemplary aspect of the disclosure, the second actuator 154 of the directional control valve 158 may be associated with a spool of an open center hydraulic valve. In other exemplary aspects of the disclosure, the second actuator 154 may be associated with any suitable structure to direct aspects of flow of hydraulic fluid through the directional control valve 158.

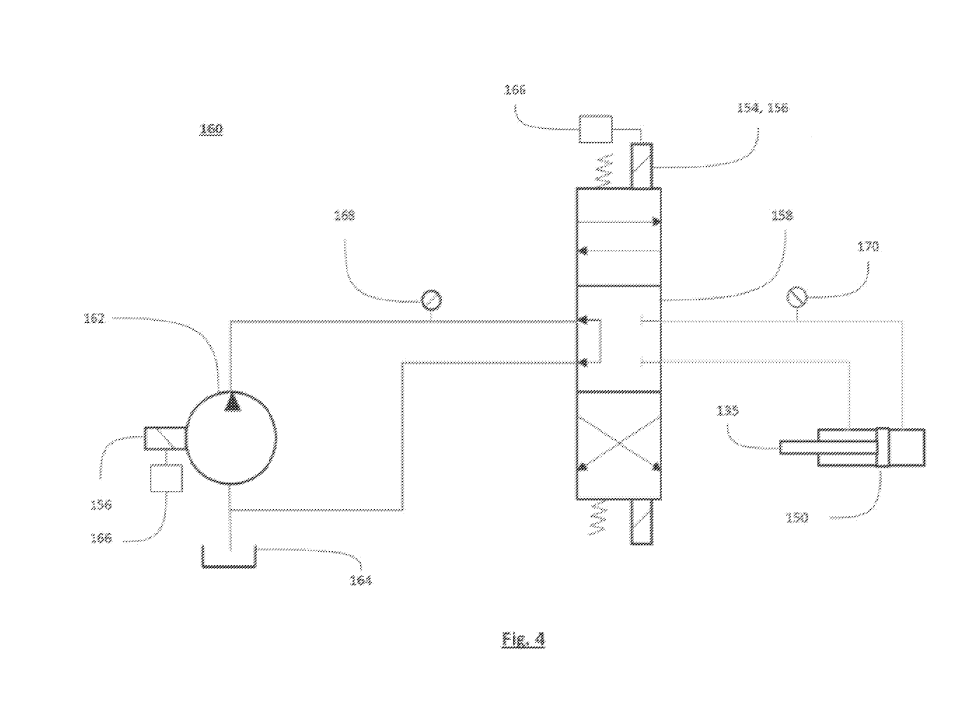

FIG. 4 depicts a schematic illustration of an aspect of a hydraulic system 160 for control of the work machine 100 and the work implement 112 of the work machine 100 according to an embodiment of the present disclosure. The hydraulic system 160 may include a hydraulic pump 162 in fluid communication with a hydraulic reservoir 164. The hydraulic system 160 may also include a directional control valve 158 disposed in fluid communication between the hydraulic pump 162 and the first actuator 150.

In some aspects of the disclosure, the step of receiving 320 signals representative of the initial position 322 of the second actuator 154 may indicate the initial position 322 of the second actuator 154 associated with the directional control valve 158. In further aspects, the signals representative of the initial position 322 of the second actuator 154 may indicate the initial position 322 of the second actuator 154 associated with the hydraulic pump 162. In an exemplary aspect, signals representative of the initial position 322, or any other position, of an actuator, including the second actuator 154, may include signals derived from a combination of calculated estimates, direct measurements, or any combination thereof, and may incorporate data from multiple sources and sensors to ensure reliability and accuracy. Calculated or estimated signals may be generated based on information available from the second actuator 154 itself and/or from system dynamics that may predict actuator behavior based on input commands and known characteristics of the work machine 100 and control system 200. Signals representative of the position of the actuator may also include signals of direct measurement of the actuator’s position and may be achieved using applicable position sensors, including but not limited to linear variable differential transformers (LCDTs), potentiometers, or optical encoders. Various other signals representative of characteristics associated with structures utilizing in the method 300 may similarly include derived from a combination of calculated estimates, direct measurements, or any combination thereof.

Each second actuator 154 of the plurality of second actuators 156 may be operably associated with a second sensor 166 configured to measure the position of the second actuator 154. The plurality of second actuators 156 may be an aspect of the sensor system 136 and may be provided as similar or same type sensors as described with respect to the sensor system 136 or any other suitable sensor to determine a position of the second actuator 154.

The method 300 may include utilizing the initial position 322 of the second actuator 154 as part of a process of compensating for various flow and pressure characteristics associated with accurate control of the hydraulic system 160 of the work machine 100. Based at least on the initial position 322 of the second actuator 154, the method 300 includes generating 324 a valve force control signal 326 to control a subsequent position 328 of the second actuator 154 and generating 330 a flow control signal 332 to control an output 334 of the hydraulic pump 162. In an exemplary aspect of the work machine 100, the valve force control signal 326 may indicate a target force to apply to the second actuator 154. Also, the flow control signal 332 may indicate a flow target for the hydraulic pump 162. The control system 200, including the controller 202, may translate forces associated with the valve force control signal 326 and the flow control signal 332 to a pilot pressure and drive current (optionally expressed in mA) for further compatibility with additional systems and components of the method 300.

As discussed further herein, the method 300 utilizing the initial position 322 of the second actuator 154 to generate the valve force control signal 326 for the subsequent position 328 of the second actuator 154 and to generate the flow control signal 332 for the output 334 of the hydraulic pump 162 provides for dynamic valve compensation associated with the positions of open-center valves present throughout the work machine 100 and the work implement 112 of the work machine 100. This type of dynamic valve compensation may be characterized as an open-loop control 336.

The method 300 may repeat the steps of generating 302 the velocity request 304, receiving 306 the velocity measurement signal 308 and generating the velocity control signal 312 based on the valve force control signal 326 and the flow control signal 332.

In some aspects of the disclosure, the method 300 may include a step of determining 338 a flow force 340, a step of determining 342 a spool force 344, a step of determining 346 a valve passage flow 348, and a step of determining 350 an expected regenerative flow 352.

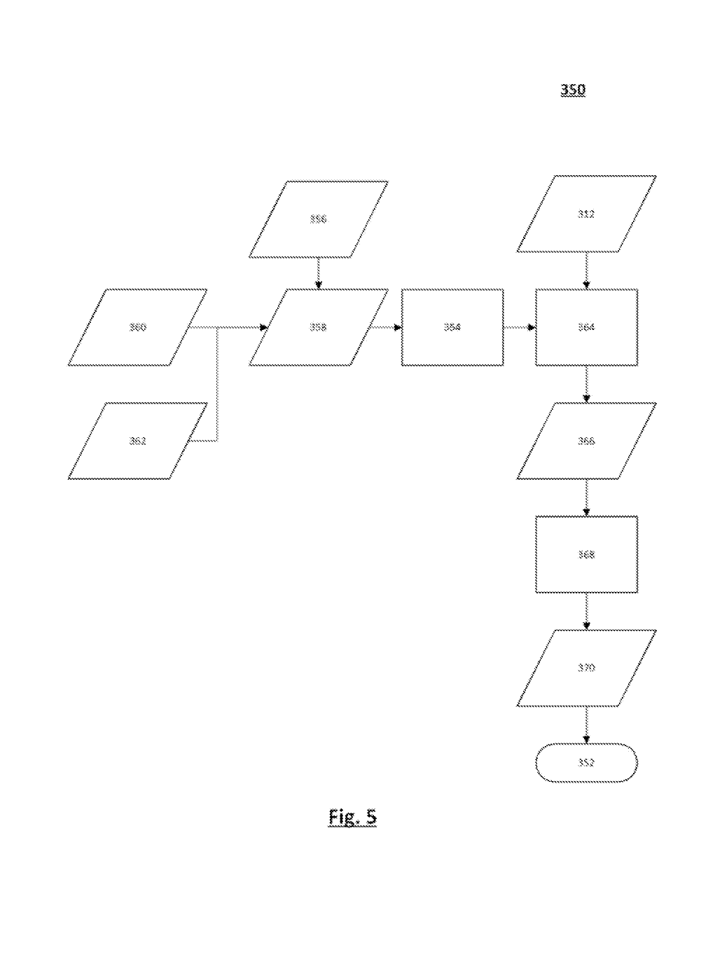

FIG. 5 depicts an aspect of the step of determining 350 the expected regenerative flow 352 according to the disclosure. In some aspects of the disclosure, the step of determining 350 the expected regenerative flow 352 may include a step of receiving 354 a pump output pressure signal 356 or a signal representative of an output pressure of the hydraulic pump 162. The pump output pressure signal 356 may be generated at a pressure sensor 168 or a pressure transducer disposed between the hydraulic pump 162 and the directional control valve 158. The step of determining 350 the expected regenerative flow 352 may further include receiving a plurality of pressure signals 358 or a plurality of signals representative of the system pressure of the hydraulic system 160. The plurality of pressure signals 358 representative of the system pressure may include at least the pump output pressure signal 356. The plurality of pressure signals 358 may collectively contribute to a load observer control system the monitors system pressures and evaluates an expected load dependency based on a function of the work machine 100 and a load on any particular actuator.

Regenerative flow, while beneficial for enhancing actuator velocities in manual operations of the excavator hydraulic system 160, can be problematic for automation systems aiming to achieve precise actuator velocities. This supplementary flow, being dependent on the hydraulic pressure differentials between the regenerative path and the flow path back to the hydraulic reservoir, varies with the load conditions. To address this issue, the load observer control system utilizes the plurality of pressure signals 358, which include the pump output pressure signal 356, to evaluate the expected load dependency on a function of the work machine 100. It then determines the quantity of flow 352 that will regenerate into the actuator and adjust its velocity accordingly. This method effectively tailors the flow redirected back to the actuator, optimizing control over the actuator velocity in response to dynamic operational demands.

In some aspects of the disclosure, the step of receiving 354 the plurality of pressure signals 358 may include receiving an inlet pressure signal 360 representative of a pressure at an inlet of the first actuator 150, the second actuator 154, any actuator within the hydraulic system 160 of the work machine 100, or a combination thereof. The step of receiving 354 the plurality of pressure signals 358 may further include receiving an outlet pressure signal 362 representative of a pressure at an outlet of the first actuator 150, the second actuator 154, any actuator within the hydraulic system 160 of the work machine 100, or a combination thereof. The step of receiving 354 the plurality of pressure signals 358 may include receiving both the inlet pressure signal 360 and the outlet pressure signal 362.

The plurality of pressure signals 358 may indicate the system pressure of the hydraulic system 160 and may include signals representative of pressure on both sides of the directional control valve 158, the second actuator 154, or any one of the plurality of second actuators 156. Where the plurality of pressure signals 358 indicate pressure on both sides of any actuator, the plurality of pressure signals 358 may indicate the system pressure and load applicable to the particular actuator for which the system pressure is measured.

In some aspects of the disclosure, the step of determining 350 the expected regenerative flow 352 may include a step of estimating 364 an actuator load 366 based on the plurality of pressure signals plurality of pressure signals 358 and the velocity control signal 312. In an exemplary aspect, the step of estimating 364 the actuator load 366 estimates the load on the first actuator 150 based upon the plurality of pressure signals 358, which includes the pump output pressure signal 356, and the velocity control signal 312.

The step of determining 350 the expected regenerative flow 352 may further include a step of generating 368 a regenerative flow signal 370, an output signal representing a quantity of flow to regenerate into the first actuator 150. The regenerative flow signal 370 may indicate to the control system 200 a quantity of flow to regenerate into the actuator and contribute to its velocity.

In some aspects of the disclosure, the method 300 may include generating 330 the valve force control signal 326 based on the regenerative flow signal 370, the expected regenerative flow 352, or a combination thereof. By modifying the valve force control signal 326 with signals representing an expected regenerative flow and the associated compensation needed for such regenerative flow, the control of the subsequent position 328 of the second actuator 154 may account for the expected regenerative flow 352.

In some aspects, the step of determining 342 the spool force 344 includes measuring the force and direction associated with the second actuator 154 of the directional control valve 158. The step of determining 342 the spool force 344 is based at least on the initial position 322 of the second actuator 154.

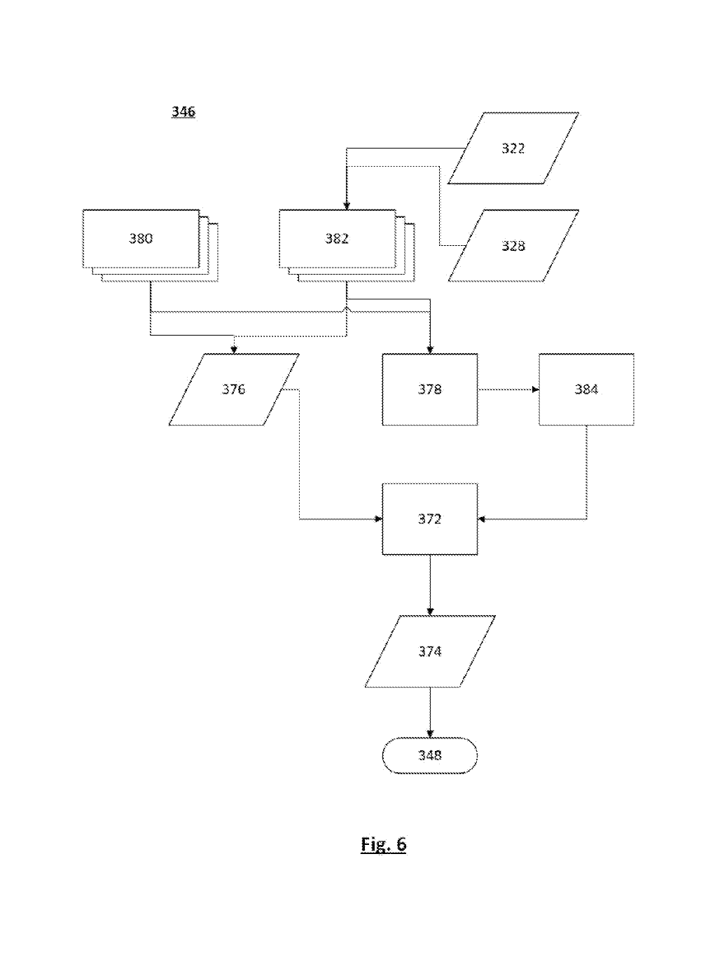

FIG. 6 depicts an aspect of the step of determining 346 the valve passage flow 348 according to the disclosure. The step of determining 346 the valve passage flow 348 may compensate for anticipated flow losses through the directional control valve 158. In an exemplary aspect of the disclosure, the directional control valve 158 may be provided as an open center hydraulic valve with a valve center passage and flow losses occurring through the valve center passage. The step of determining 346 the valve passage flow 348 may determine the expected or measured split of flow across the directional control valve 158 to determine how much additional flow from the hydraulic pump 162 is required to account for any estimated or measured loss of flow.

In some aspects of the disclosure, the step of determining 346 the valve passage flow 348 may include a step of determining 372 a flow rate 374 associated with the initial position 322 of the second actuator 154. The step of determining 372 the flow rate 374 may be based on reference to a predefined flow metering curve 376 associated with the directional control valve 158. The flow metering curve, or flow characteristic curve, may represent the relationship between an opening position of the valve (or a control signal associated with any opening position of the valve) and the flow rate of the fluid passing through the valve at that position. The flow metering curve may illustrate how the flow rate changes as the valve moves from a fully closed to a fully open position and may further indicate different flow characteristics associated with each flow rate, including exemplary flow metering curves like linear, equal percentage, or quick opening. A linear flow metering curve may indicate a proportional change in flow rate with valve position. An equal percentage flow metering curve may indicate a logarithmic increase in the flow rate. A quick opening flow metering curve may indicate a rapid increase in flow rate at the initial valve opening.

In some aspects of the disclosure, the step of determining 346 the valve passage flow 348 may include dynamically receiving 378 flow rates 380 at locations both upstream and downstream of the directional control valve 158, indicating flow differences across the directional control valve 158. Flow difference across the directional control valve 158 may be generated by the pressure sensor 168 or a third sensor 170 that may act as a flow sensor. the hydraulic system 160 may include any number of a plurality of third sensor 170 to provide flow measurements applicable to any one of the plurality of second actuators 156. The step of determining 346 the valve passage flow 348 may further include dynamically receiving 378 a signal representing a plurality of positions 382 of the second actuator 154 associated with the directional control valve directional control valve 158. The signals 380 representing the flow differences across the directional control valve 158 and the signals 382 representing the position of the second actuator 154 may be matched along a time measurement (time-series matching 384) to indicate which particular position of the second actuator 154 of the directional control valve 158 is associated with which particular flow difference across the directional control valve 158. In this manner, determining 346 the valve passage flow 348 may be accomplished through dynamic system modeling. In some aspects, the valve passage flow 348 may indicate a flow loss rate corresponding to the initial position 322 of the second actuator 154. The method 300 may further provide the valve passage flow 348 to indicate a flow loss rate across the directional control valve 158 corresponding to any number of the subsequent position 328 of the second actuator 154.

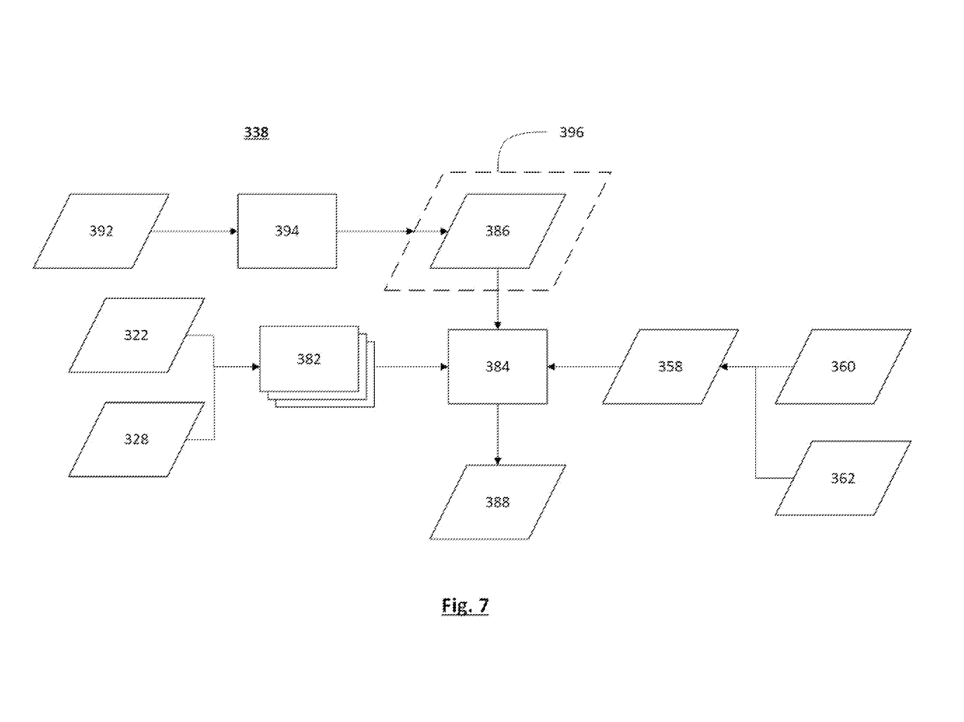

FIG. 7 depicts an aspect of the step of determining 338 the flow force 340 according to the disclosure. In some aspects of the disclosure, the step of determining 338 the flow force 340 may include dynamically receiving signals representing flow force data 386. The signals representing the flow force data may be generated by a plurality of sensors associated with the second actuator 154 of the directional control valve 158, including the third sensor 170. The plurality of sensors may indicate the forces exerted by hydraulic fluid flow on the second actuator 154, the directional control valve 158, any structure associated with directing flow through the directional control valve 158, or a combination thereof. Example forces may include hydrodynamic forces created by flow through orifices of the directional control valve 158, which can exert forces on the second actuator 154 and directional control valve 158.

The step of determining 338 the flow force 340 may further include dynamically receiving a signal representing a plurality of positions of the second actuator 154. The signals representing the positions of the second actuator 154 may be generated by the second sensor 166. In some aspects, determining 338 the flow force 340 may include dynamically receiving signals from the second sensor 166 representing a plurality of position of each of the plurality of second actuators 156, including the second actuator 154. The plurality of position of the second actuator 154 may include the initial position 322 and the subsequent position 328 of the second actuator 154.

The step of determining 338 the flow force 340 may include time series matching 384 the signals representing flow force data to signals representing the plurality of positions 382 of the second actuator 154, where each signal includes a plurality of measurement over a period of time. The signals representing the flow force data on the second actuator 154 and directional control valve 158 and the signals representing the position of the second actuator 154 may be matched along a time measurement to indicate which particular position of the second actuator 154 of the directional control valve 158 is associated with which particular flow force is exerted on the directional control valve 158. In this manner, determining 338 the flow force 340 may be accomplished through dynamic system modeling. Based upon the time series matching of the flow force 340 and the positions of the second actuator 154, the step of determining 338 the flow force 340 may include generating an output signal representing a compensated flow force 388. The compensated flow force 388 may indicate the forces exerted on the directional control valve 158 over varying flow and position scenarios and may be used to anticipate the flow forces to be imposed on the directional control valve 158 and modify the valve force control signal 326 to account for the additional flow force 340.

The method 300 may further include an error calculation where the flow force 340 and the spool force 344 are added to produce the compensated flow force 388.

In some aspects of the disclosure, the step of generating 324 the valve force control signal 326 may include dynamically comparing the valve force control signal 326 to the subsequent position 328 of the second actuator 154 over time. Based on this dynamic comparison, generating 324 the valve force control signal 326 may further include dynamically generating a compensatory signal 390 and modifying the valve force control signal 326 with the compensatory signal 390. In some aspects, the compensatory signal 390 may indicate modeling for hysteresis associated with the directional control valve 158 and the force associated with the second actuator 154 over time. In this manner, the compensatory signal 390 may provide modeling of a hysteresis behavior by indicating the relationship between the valve force control signal 326 and the position of the second actuator 154 of the directional control valve 158.

In some aspects of the disclosure, the step of determining 338 the flow force 340 may include receiving a first data set 392, which includes a variety of predefined system data. From this initial collection of data, a second data set 396 is derived using a dynamic system model 394. The dynamic system model 394 may predict how the directional control valve 158 responds to different flow rates, flow forces, and positions of the second actuator 154, with such flow rates, flow forces, and actuator positions being measured components of the dynamic system model 394. This second data set specifically contains flow force data 386. The dynamic system model 394 then uses this flow force data 386 to dynamically estimate 384 the flow forces associated with a range of positions of the second actuator. These positions include both the initial and subsequent positions of the actuator. Finally, based on these dynamically estimated flow force data, an output signal is generated. This signal represents a flow force that has been compensated for any changes in the actuator positions.

In some aspects of the disclosure, the step of generating 324 the valve force control signal 326 may include receiving first data set 392, which includes a plurality of compared data. The plurality of compared data represents the comparison of the valve force control signal 326 to the subsequent position 328 of the second actuator 154. Generating 324 the valve force control signal 326 may further include utilizing a dynamic system model 394 to derive the second data set 396 that includes a hysteresis compensator. Generating 324 the valve force control signal 326 may further include dynamically estimating the hysteresis compensator using the second data set 396 and the plurality of positions 382 of the second actuator 154, including the initial position 322 and the subsequent position 328. In this manner, the dynamic system modeling for hysteresis actively compensates for any hysteresis effect associated with changes in the actuator’s position.

In some aspects of the disclosure, the step of generating 330 the flow control signal 332 may be based on the initial position 322 of the second actuator 154, the flow force 340 and the spool force 344.

In some aspects of the disclosure, the step of generating 324 the valve force control signal 326 may be based the valve passage flow 348, the expected regenerative flow 352 and the velocity control signal 312.

In some aspects of the disclosure, repeating the steps of generating 302 the velocity request 304, receiving 306 the velocity measurement signal 308, and generating the velocity control signal 312 based on the valve force control signal 326 and the flow control signal 332 may further include generating the target error 316 by comparing the velocity request 304 with the velocity measurement signal 308. In an exemplary aspect, the target error 316 may be generated by subtracting the velocity measurement signal 308 from the velocity request 304, which may indicate the error difference between the actual performance and the desired performance. The method 300 may further include modifying the velocity control signal 312 with the target error 316.

In some aspects of the disclosure, the P-I closed loop control 318 may include generating a proportional target error and an integral target error, combining both the proportional target error and the integral target error, and modifying the target error 316 with the combination of the proportional target error and the integral target error. In an exemplary aspect, the proportional target error may indicate an adjustment of the target error 316 proportionally to the error to aid in reducing the magnitude of the error. The integral target error may indicate an adjustment of the target error 316 based on the accumulation of past errors to eliminate steady-state error and ensure the desired velocity is achieved.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method of controlling a rate of movement of a work implement for a work machine, comprising:
receiving signals representative of an initial position of a second actuator, where the second actuator is one or more of a plurality of second actuators associated with a directional control valve, the directional control valve being operably disposed between a hydraulic pump and the first actuator;
based at least upon the initial position of the second actuator, generating a valve force control signal to control a subsequent position of the second actuator and generating a flow control signal to control an output of a hydraulic pump; and
repeating steps (a)–(c) based on the valve force control signal and the flow control signal.

2. The method of claim 1, further comprising:
determining, based at least on the initial position of the second actuator, a flow force, a spool force, a valve passage flow, and an expected regenerative flow;
generating, based at least on the initial position of the second actuator, the flow force, and the spool force, the valve force control signal to control the subsequent position of the second actuator; and
generating, based on the valve passage flow, the expected regenerative flow, and the velocity control signal, the flow control signal to control the output of the hydraulic pump.

3. The method of claim 2, further comprising:
receiving, from a pressure sensor disposed between the hydraulic pump and the directional control valve, a signal representative of an output pressure of the hydraulic pump;
wherein determining the expected regenerative flow comprises:
receiving a plurality of signals representing a system pressure, where one of the plurality of signals representing the system pressure comprises the signal representing the output pressure of the hydraulic pump;
estimating, based on the plurality of signals representing the system pressure and the velocity control signal, a load of the first actuator; and
generating, based on the load of the first actuator, an output signal representing a quantity of flow to regenerate into the first actuator.

4. The method of claim 3, wherein receiving a plurality of signals representing the system pressure comprises:
receiving a signal representing a pressure at an inlet of the first actuator, an outlet of the first actuator, or both.

5. The method of claim 2, further comprising:
generating, based at least on the expected regenerative flow, the valve force control signal to control the subsequent position of the second actuator.

6. The method of claim 2, wherein determining the valve passage flow comprises:
determining, based at least on a predefined flow metering curve associated with the directional control valve, a flow rate representative of the initial position of the second actuator, wherein the predefined flow metering curve comprises a plurality of flow rates respectively associated with a plurality of positions of the second actuator.

7. The method of claim 1, wherein determining the flow force comprises:
dynamically receiving, from one or more of a plurality of sensors, at least one signal representing a flow force data;
dynamically receiving a signal representing a plurality of positions of the second actuator, the plurality of positions of the second actuator comprising the initial position and the subsequent position of the second actuator;
time series matching the at least one signal representing flow force data to the signal representing the plurality of positions of the second actuator, where the at least one signal representing flow force data and the signal representing the plurality of positions of the second actuator each comprise a plurality of measurements over a period of time; and
generating, based on the time series matching, an output signal representing a compensated flow force.

8. The method of claim 2, wherein determining the flow force comprises:
receiving a first data set, the first data set comprising a plurality of predefined system data;
deriving, through dynamic system modeling and from the first data set, a second data set, the second data set comprising flow force data;
dynamically estimating, based upon the second data set of the dynamic system model, a flow force data according to a plurality of positions of the second actuator, the plurality of positions of the second actuator comprising the initial position and the subsequent position of the second actuator; and
generating, based on the dynamically estimated flow force data, an output signal representing a compensated flow force.

9. The method of claim 7, wherein generating the valve force control signal further comprises:
dynamically comparing the valve force control signal to the subsequent position of the second actuator;
dynamically generating, based on the dynamically compared valve force control signal to the subsequent position of the second actuator, a compensatory signal; and
modifying the valve force control signal with the compensatory signal.

10. The method of claim 8, wherein generating the valve force control signal further comprises:
receiving a plurality of compared data, the plurality of compared data representing a comparison of the valve force control signal to the subsequent position of the second actuator;
deriving, through dynamic system modeling and from the plurality of compared data, a hysteresis compensator; and
dynamically estimating the hysteresis compensator according to a plurality of positions of the second actuator, the plurality of positions of the second actuator comprising the initial position and the subsequent position of the second actuator.

11. The method of claim 1, wherein repeating step (c) further comprises:
generating a target error by comparing the velocity request with the signal representing the velocity measurement; and
modifying the velocity control signal with the target error.

12. The method of claim 11, further comprising:
generating a proportional target error;
generating an integral target error;
combining the proportional target error and the integral target error; and
modifying the target error with the combined proportional target error and integral target error.

13. A work machine, comprising:
a work implement;
a hydraulic pump;
a first actuator associated with the work implement of the work machine;
at least one first sensor operably connected to the first actuator;
a directional control valve disposed between the hydraulic pump and the first actuator;
a second actuator operably connected to the directional control valve;
a second sensor operably connected to the second actuator, the second sensor configured to generate a position signal representing a position of the second actuator; and
a controller configured to generate a velocity request signal for regulating a velocity of the first actuator, the controller further configured to:
determine, from the at least one first sensor, a velocity error of the first actuator based on a velocity measurement signal representing a velocity of the first actuator and on an initial velocity control signal;
generate, based on the velocity error, an actuator velocity control signal;
determine, from the second sensor, an initial position of the second actuator; and
generate, based upon the initial position and the actuator velocity control signal, a plurality of control signals, where the plurality of control signals comprises a second actuator control signal and a hydraulic pump flow control signal.

14. The work machine of claim 13, further comprising:
a first pressure sensor disposed between the hydraulic pump and the directional control valve, the first pressure sensor providing a signal representing a pressure of the hydraulic pump;
wherein the controller is further configured to generate, based on the signal representing the pressure of the hydraulic pump and the initial position of the second actuator, a control signal representing a quantity of flow to regenerate into the first actuator.

15. The work machine of claim 14, further comprising:
a second pressure sensor disposed at an inlet of the first actuator, an outlet of the first actuator, or both, the second pressure sensor providing a signal representing a pressure associated with the first actuator;
wherein the controller is further configured to:
estimate, based at least on the first pressure sensor and the second pressure sensor, a load of the first actuator; and
generate, based on the load of the first actuator, the control signal representing a quantity of flow to regenerate into the first actuator.

16. The work machine of claim 13, further comprising:
a third sensor configured to generate a plurality of flow signals, each of the plurality of flow signals representing a flow across the directional control valve;
wherein the controller is further configured to:
dynamically receive, from the third sensor, the plurality of flow signals respectively associated with a plurality of positions of the second actuator, the plurality of positions of the second actuator comprising the initial position; and
determine, based on the plurality of flow signals respectively associated with the plurality of positions of the second actuator, a flow loss rate corresponding to the initial position of the second actuator.

17. The work machine of claim 13, further comprising:
a first pressure sensor disposed between the hydraulic pump and the directional control valve, the first pressure sensor providing a pressure signal representing a pressure of the hydraulic pump; and
a third sensor configured to generate a flow force input signal, the flow force input signal representing a flow force associated with the directional control valve;
wherein the controller is further configured to:
dynamically receive the position signal, the pressure signal, and the flow force input signal, where each of the position signal, the pressure signal, and the flow force input signal comprise a plurality of measurements over a period of time;
associate the flow force input signal with the position signal and the pressure signal; and
generate, based on the flow force input signal associated with the position signal and the pressure signal, a flow force compensation signal.

18. The work machine of claim 17, wherein the controller is further configured to:
dynamically compare the position signal to the flow force compensation signal, the position signal and the flow force compensation signal comprise a plurality of measurements over the period of time;
dynamically generate, based on the dynamically compared position signal and flow force compensation signal, a hysteresis compensation signal; and
modify the second actuator control signal with the hysteresis compensation signal.

19. The work machine of claim 13, wherein the controller is further configured to:
generate, from the velocity error, a proportional target error;
generate, from the velocity error, an integral target error;
combine the proportional target error and the integral target error; and
modify the actuator velocity control signal with the combined proportional target error and integral target error.
